(19) United States
(12) Patent Application Publication
(10) Pub. No.: US 2017/0263138 A1
(43) Pub. Date: Sep. 14, 2017

(54) Method for Providing a Collision Avoidance System for an Ownship

(71) Applicants: Stephen O'Day, Hollywood, MD (US); Kristopher Melton, Leonardtown, MD (US); Matthias Stark, Lexington Park, MD (US); Carl Reichelt, California, MD (US)

(72) Inventors: Stephen O'Day, Hollywood, MD (US); Kristopher Melton, Leonardtown, MD (US); Matthias Stark, Lexington Park, MD (US); Carl Reichelt, California, MD (US)

(73) Assignee: United States of America as represented by the Secretary of the Navy, Patuxent River, MD (US)

(21) Appl. No.: 15/065,368

(22) Filed: Mar. 9, 2016

(51) Int. Cl. G08G 5/04; G08G 5/00; G01C 21/12

(52) U.S. Cl. CPC G08G 5/045; G01C 21/12; G08G 5/0069; G08G 5/0026; G08G 9/02

(57) ABSTRACT

The present invention is a method for providing a collision avoidance system for an ownship, the method includes displaying a map that moves with the ownship and displays collision risk zones, extracting position and velocity measurements of platforms in the air from formatted sensor data, calculating distance from the ownship to each platform, marking radar tracks of each platform based on proximity to the ownship, assigning and displaying velocity vectors to each moving platform, and assigning and displaying different marks to each platform based on dead reckoning and potential impacts between each platform and the ownship.

### STATEMENT OF GOVERNMENT INTEREST

The invention described herein may be manufactured and used by or for the Government of the United States of America for governmental purposes without payment of any royalties thereon or therefor.

### BACKGROUND

Unmanned aerial vehicles (UAVs) or remotely piloted aircraft are vehicles that are flown without a human pilot on board. The flight of a UAV is controlled either autonomously by onboard computers or by the remote control of a pilot on the ground or in another vehicle. When the UAV is controlled by a pilot, he/she may lose sight of the UAV and not see other vehicles or platforms that may potentially collide with the UAV.

There is a need for a method for providing a UAV pilot a collision avoidance system so that the UAV or ownship does not collide with other platforms or vehicles that may be in the UAV's proximity. An ownship may be defined, but without limitation, as the vehicle or platform that is being flown or utilizing the method described herein.

### SUMMARY

The present invention is directed to a method for providing a collision avoidance system for an ownship or UAV, with the needs of the method enumerated above and below.

The present invention is directed to a method for providing a collision avoidance system for an ownship, the method includes displaying a map that moves with the ownship and displays collision risk zones, extracting position and velocity measurements of platforms in the air from formatted sensor data (such as, but without limitation, radar data), calculating distance from the ownship to each platform, marking radar tracks of each platform based on proximity to the ownship, assigning and displaying velocity vectors to each moving platform, and assigning and displaying different marks to each platform based on dead reckoning and potential impacts between each platform and the ownship.

It is a feature of the invention to provide a method for a collision avoidance system for an ownship that can be used on UAVs or any other type of appropriate vehicles.

It is a feature of the invention to provide an air traffic situational awareness display for Unmanned Aircraft System (UAS)/UAV pilots that allows them to prioritize air traffic collision threats.

It is a feature of the present invention to provide a UAS/UAV pilot with air traffic icon features that can be used to make collision avoidance maneuver decisions.

It is a feature of the present invention to provide a collision dead reckoning line (a dead reckoning line may be defined, but without limitation, as a line from the icon of the ownship in the direction of travel) that indicates whether a near-miss safety volume is predicted to be pierced by the nearby aircraft.

### DESCRIPTION

The preferred embodiments of the present invention are illustrated by way of example below. The method for providing a collision avoidance system for an ownship includes displaying a map that moves with the ownship and displays collision risk zones, extracting position and velocity measurements of platforms in the air from formatted sensor data, calculating distance from the ownship to each platform, marking radar tracks of each platform based on proximity to the ownship, assigning and displaying velocity vectors to each moving platform, and assigning and displaying different marks to each platform based on dead reckoning and potential impacts between each platform and the ownship.

In the description of the present invention, the invention will be discussed in a military aircraft environment; however, this invention can be utilized for any type of application that requires a method for providing a collision system for a vehicle or platform.

In the preferred embodiment, when the map is displayed, the display includes a moving map with an overlay of colored air traffic icons and a set of four reference concentric ellipsoid projections that travel with the ownship. The four reference concentric ellipsoid projections are an inner flashing collision alert ellipsoid, an inner flashing warning alert ellipsoid, a middle ellipsoid, and an outer ellipsoid. Each ellipsoid is calculated as follows:

inner flashing collision alert ellipsoid: 1=(x²+y)²+z²/0.0089675 (Equation 1)

inner flashing warning alert ellipsoid: 1=(x²+y)²)/9+z²/0.03587 (Equation 2)

middle ellipsoid: 1=(x²+y²)/900+z²/0.03587 (Equation 3)

outer ellipsoid: 1=(x²+y²)/900+z²/0.3228305 (Equation 4)

The icons may be red (traffic platform within ±1000 ft altitude difference/3 mile ellipsoid separation), yellow (±3000 ft altitude difference/30 mile ellipsoid separation), or green (outside all rings) based on proximity to the ownship. Icons of any color will get dead reckoning line extensions from the nose if a future piercing of the ownship inner flash warning ellipsoid (±1000 ft altitude difference/1 mile separation from the ownship) is projected based on the current kinematic state of the air platform. The dead reckoning mathematics is done in the body frame of the ownship by setting the first derivative with respect to time of the 3D distance equation to zero, solving for time, and plugging the time of closest approach back into the distance equation. Ground, surface, and air-to-air radar feeds such as, but without limitation, Asterix or CD2 format are combined in this system with the lowest error feeds used for the map and calculations.

A description of how the position and the velocity of each air traffic platform are extracted/calculated in the ownship frame of reference follows. The Air traffic platform position calculations take place in the IEEE 1278.1 Cartesian Body Frame of the ownship represented by the XTGT_{body} matrix whose components xₒ, yₒ, and zₒ are used in equation 8 (listed below). Note that the ownship/UAS is stationary at origin of the body reference frame. After the Earth Tangent reference frame position and velocity measurements are extracted from the radar data, the distance from the ownship to each platform is calculated by using the following equation:

XTGT_{body}=M_{EarthTangent}_{_}ₜₒ_{_}_{body}*(XTGT_{EarthTangent}−XUAS_{EarthTangent}) (Equation 5)

where:
XTGT_{EarthTangent} is the 3×1 position matrix of air traffic aircraft in an Earth-referenced Cartesian frame;
XUAS_{EarthTangent} is the 3×1 position of the ownship in an Earth-referenced Cartesian frame;
M_{EarthTangent}_{_}ₜₒ_{_}_{body} is 3×3 transformation from Earth-referenced frame to body UAS frame; and,

$${M}_{EarthTangent \_ to \_ body} = [ \begin{matrix}{C}_{θ} {C}_{ψ} & {C}_{θ} {S}_{ψ} & - {S}_{θ} \\ - {S}_{ψ} {C}_{φ} + {S}_{φ} {S}_{θ} {C}_{ψ} & {C}_{φ} {C}_{ψ} + {S}_{ψ} {S}_{θ} {S}_{φ} & {S}_{φ} {C}_{θ} \\ {S}_{φ} {S}_{ψ} + {C}_{φ} {S}_{θ} {C}_{ψ} & - {S}_{φ} {C}_{ψ} + {C}_{φ} {S}_{θ} {S}_{ψ} & {C}_{θ} {C}_{φ}\end{matrix} ] \qquad ( Equation 6 )$$

Note that C and S are abbreviations for cosine and sine and the subscripts are the Tait-Bryan Euler angles psi, theta, and phi of the UAS (ownship) in the Earth-referenced frame.

The velocity measurements of the platforms in the air are calculated as follows. A 3×1 matrix is used for traffic target velocity. The 3×1 matrix for traffic target velocity VTGT_{body} has components vₓ, v_{y}, and v_{z} in the body frame of the UAS and is calculated by Equation 7:

VTGT_{body}=M_{EarthTangent}_{_}ₜₒ_{_}_{body}*(VTGT_{EarthTangent}−VUAS_{EarthTangent}) (Equation 7)

where:
VTGT_{EarthTangent} is the 3×1 velocity matrix of air traffic aircraft in an Earth-referenced Cartesian frame; and,
VUAS_{EarthTangent} is the 3×1 velocity of the UAS ownship in an Earth-referenced Cartesian frame.

The distances from the ownship to each platform are calculated as follows. The XTGT_{body} and VTGT_{body} components calculated in equations 5-7 are used to calculate the distance S (Equation 8) which is differentiated to find the time at which it is of minimum value (Equation 5):

S=((xₒ+vₓt)²+(yₒ+v_{y}t)²+(zₒ+v_{z}t)²)^{1/2} (Equation 8)

dS/dt=0 at minimum missed distance

dS/dt=0=(xₒvₓ+vₓ²tₘ+yₒv_{y}+v_{y}²tₘ+zₒv_{z}+v_{z}²tₘ)/((xₒ+vₓtₘ)²+(yₒ+v_{y}tₘ)²+(zₒ+v_{z}tₘ)²)^{1/2}

tₘ=−(xₒvₓ+yₒv_{y}+zₒv_{z})/(vₓ²+v_{y}²+v_{z}²). (Equation 9)

The time at which minimum separation occurs is used to compare with the safety ellipsoid boundary in order to determine whether a nose intercept line will be present on the icon.

A Nose Intercept Line drawn if:

1>=((xₒ+vₓtₘ)²+(yₒ+v_{y}tₘ)²)/9+(zₒ+v_{z}tₘ)²/0.03587. (Equation 10)

Equation 7 assumes a 3 mile radial horizontal plane boundary and +/−1000 feet altitude z_max. Note that 3 mi*3 mi=9 mi-sq and (1000 ft/5280 ft/mi)*(1000 ft/5280 ft/mi)=0.0358700 mi-squared.

The display overlay may show the following icons with colors and color changes depending on the volume in which the aircraft traffic platform resides:
Green Icon if: 1<(xₒ²+yₒ²)/900+zₒ²/0.3228305 since 30*30=900 mi-sq and (3000 ft/5280 ft)*(3000 ft/5280 ft/mi)=0.3228305 mi-sq
Yellow Icon if: 1>=(xₒ²+yₒ²)/900+zₒ²/0.3228305 and 1<(xₒ²+yₒ²)/900+zₒ²/0.03587 since (1000 ft/5280 ft/mi)*(1000 ft/5280 ft/mi)=0.0358700 mi-sq
Red Icon if: 1>=(xₒ²+yₒ²)/900+zₒ²/0.03587.

The radar tracks of each platform are marked based on proximity to the ownship. Radar tracks may be defined, but without limitation, as small aircraft icons with coloration based on proximity and lines emanating from the nose if they are a collision risk.

Velocity vectors for each moving platform are assigned and displayed. The velocity vectors are obtained from reference library calls.

Different marks for each platform are assigned and displayed based on dead reckoning and potential impacts between each platform and the ownship. Dead reckoning is defined, but without limitation, as projecting a measured position to the projected future time position using current time measurements of velocity, position, and time. The marks are assigned by extending a line from the nose of the icon.

The outer ellipsoid and middle ellipsoids may remain fixed in color. The inner ellipsoids may flash for a number of seconds after being pieced.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A method for providing a collision avoidance system for an ownship, the method comprising:
displaying a map displaying a map that moves with the ownship and displays collision risk zones;
extracting position and velocity measurements of platforms in the air from formatted sensor data;
calculating distance from the ownship to each platform;
marking radar tracks of each platform based on proximity to the ownship;
assigning and displaying velocity vectors to each moving platform; and,
assigning and displaying different marks to each platform based on dead reckoning and potential impacts between each platform and the ownship.

2. The method for providing a collision avoidance system for an ownship of claim 1, wherein the map includes an overlay of colored air traffic icons and a set of four reference concentric ellipsoid projections that travel with the ownship, each ellipsoid projection based on the proximity of air traffic to the ownship, and a warning is given when air traffic enters each ellipsoid projection.
